(19) United States
(12) Patent Application Publication
(10) Pub. No.: US 2008/0039082 A1
(43) Pub. Date: Feb. 14, 2008

(54) APPARATUS AND METHOD FOR SELECTING A CELL IN A MOBILE COMMUNICATION TERMINAL

(75) Inventor: Roe-Kwan KIM, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/777,814

(22) Filed: Jul. 13, 2007

(30) Foreign Application Priority Data
Aug. 11, 2006 (KR) 2006-76429

(51) Int. Cl. H04Q 7/20; H04B 7/00

(52) U.S. Cl. 455/434; 370/328; 455/525

(57) ABSTRACT

An apparatus and a method of cell selection/reselection or Public Land Mobile Network (PLMN) selection of a mobile communication terminal are provided. The method includes sorting observed cells according to the intensity of signals being received from the cells; checking a control information of an (i)th cell of the sorted cells and determining whether the (i)th cell is selectable and reselected as a target cell and whether the (i)th cell supports General Packet Radio Service (GPRS) and Enhanced Data Rates for Global Evolution (EDGE) service; and performing a Camp-On of the (i)th cell, upon determining that the (i)th cell is selectable and reselectable as the target cell and that the (i)th cell supports the GPRS and the EDGE service.

### PRIORITY

This application claims priority under 35 U.S.C. §119(a) to a Korean Patent Application filed in the Korean Intellectual Property Office on Aug. 11, 2006 and assigned Ser. No. 2006-76429, the contents of which are incorporated herein by reference.

### BACKGROUND OF THE INVENTION

1. Field of the Invention

The present invention relates to an apparatus and a method for providing continuous packet data service in a mobile communication terminal, and in particular, to an apparatus and a method of Public Land Mobile Network (PLMN) selection, or cell selection/reselection, which is capable of providing continuous packet data service by selecting a cell having an availability of General Packet Radio Service (GPRS) first in a mobile communication terminal.

2. Description of the Related Art

Generally, a mobile communication terminal of a wireless communication system conducts cell selection/reselection or Public Land Mobile Network (PLMN) selection to provide optimum wireless connectivity.

In the cell selection/reselection or PLMN selection, the mobile communication terminal synchronizes each cell via the Synchronization CHannel (SCH) to find a suitable cell. The mobile communication terminal then acquires information for the cell selection/reselection or PLMN selection by decoding the System Information 3 (SI3) or System Information 4 (SI4) and selects a target cell. The mobile communication terminal particularly checks the Random Access Channel (RACH) control information, Location Area Identification (LAID), and cell ID of SI3 or SI4. Here, System Information (SI) is a technical term used in a 3GPP(3^{rd} Generation Partnership Project) standard.

The mobile communication terminal of the wireless communication system supports packet data service using GPRS or Enhanced Data Rates for Global Evolution (EDGE) service. However, the mobile communication terminal does not consider whether the target cell supports the GPRS and the EDGE service, during the cell selection/reselection or PLMN selection. Accordingly, the mobile communication terminal may not be able to use the packet data service, if the target cell does not support the GPRS and the EDGE service.

### SUMMARY OF THE INVENTION

An aspect of the present invention is to substantially solve at least the above problems and/or disadvantages and to provide at least the advantages below. Accordingly, one aspect of the present invention is to provide an apparatus and a method for providing continuous packet data service in a mobile communication terminal.

Another aspect of the present invention is to provide an apparatus and a method of cell selection/reselection or PLMN selection for providing continuous packet data service in a mobile communication terminal.

Yet another aspect of the present invention is to provide an apparatus and a method of cell selection/reselection or PLMN selection of a mobile communication terminal, which considers whether a target cell supports GPRS and the EDGE service.

According to one aspect of the present invention, there is provided a method of cell selection and reselection of a mobile communication terminal. The method includes sorting observed cells according to the intensity of signals being received from the cells; checking a control information of an (i)th cell of the sorted cells and determining whether the (i)th cell is selectable and reselected as a target cell and whether the (i)th cell supports General Packet Radio Service (GPRS) and Enhanced Data Rates for Global Evolution (EDGE) service; and performing a Camp-On of the (i)th cell, upon determining that the (i)th cell is selectable and reselectable as the target cell and that the (i)th cell supports the GPRS and the EDGE service.

According to another aspect of the present invention, there is provided a method of Public Land Mobile Network (PLMN) selection of a mobile communication terminal. The method includes sorting ambient cells according to the intensity of signals being received from the cells; checking a control information of the sorted cells and determining whether the cells are selectable and reselected as a target cell and whether the cells support General Packet Radio Service (GPRS) and Enhanced Data Rates for Global Evolution (EDGE) service; adding the cells into a Camp-On list, if the cells are determined to be selectable and reselectable as the target cell and support the GPRS and the EDGE service; and re-sorting the cells of the Camp-On list and performing the Camp-On of the cells sequentially in the re-sorted order.

According to another aspect of the present invention, there is provided an apparatus for cell selection and reselection or Public Land Mobile Network (PLMN) selection of a mobile communication. The apparatus includes a sorting unit which sorts observed cells according to the intensity of signals being received from the cells; an ambient cell scanning unit which checks the cells sequentially in the sorted order and determines whether the checked cell is selectable and reselectable as a target cell; a prioritizing unit which gives priority to the cell determined by the ambient cell scanning unit to be selectable and reselectable as the target cell, according to whether or not the cell supports a General Packet Radio Service (GPRS) and an Enhanced Data Rates for Global Evolution (EDGE) service; and a control unit which causes the cell selection and reselection or PLMN selection to be conducted according to the determined priority.

### BRIEF DESCRIPTION OF THE DRAWINGS

The above and other objects, features and advantages of the present invention will become more apparent from the following detailed description when taken in conjunction with the accompanying drawings in which:

FIG. 1 is a flowchart illustrating the process of cell selection/reselection of a mobile communication terminal according to the present invention;

FIG. 2 is a flow chart illustrating the process of a PLMN selection of a mobile communication terminal according to the present invention; and

FIG. 3 is a schematic diagram of a mobile communication terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

A technique for cell selection/reselection or Public Land Mobile Network (PLMN) selection according to exemplary embodiments of the present invention will be explained below, which gives high priority to a cell that supports General Packet Radio Service (GPRS) or Enhanced Data Rates for Global Evolution (EDGE) service, and thus provides continuous packet data service in a mobile communication terminal.

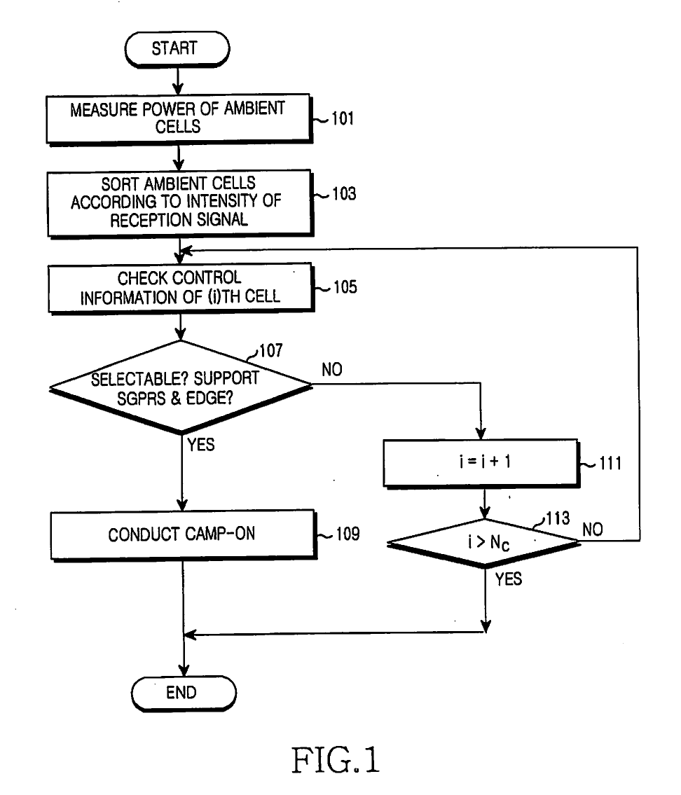

FIG. 1 illustrates the process of cell selection/reselection of a mobile communication terminal according to the present invention.

In FIG. 1, a mobile communication terminal scans the signal of all the observed cells to measure reception power of the cells in step 101.

After measuring the reception power of the cells, the mobile communication terminal proceeds to step 103 to sort the cells according to the measured reception power.

The mobile communication terminal then proceeds to step 105 and synchronizes to the (i)th cell of the sorted cells, using the Synchronization Channel (SCH). The mobile communication terminal receives a Broadcast Control Channel (BCCH) of the (i)th cell and decodes the received signal. The cells, each having initial value 1, are indexed by (i) sequentially, in the order the cells are sorted.

After decoding the BCCH of the (i)th cell, the mobile communication terminal proceeds to step 107 and determines whether the (i)th cell is selectable as a target cell, and whether the (i)th cell supports GPRS and EDGE service. In other words, the mobile communication terminal checks the Location Area Identification (LAID) of System Information 3 (SI3) or System Information 4 (SI4) contained in the BCCH and determines whether the (i)th cell can be selected as a target cell. The LAID indicates service area of the cell.

The mobile communication terminal also checks the GPRS indicator through the Rest Octet of SI3 or SI4 and determines whether the cell supports the GPRS service. The mobile communication terminal then checks the GPRS service parameters of System Information 13 (SI13) contained in the BCCH and determines whether the cell supports the EDGE service according to the GPRS cell option of SI13.

If it is determined that the (i)th cell can be selected as a target cell and that the (i)th cell supports the GPRS and the EDGE service, the mobile communication terminal proceeds to step 109 and conducts Camp-On with the (i)th cell. Thereafter, the mobile communication terminal ends the process.

If, however, it is determined that the (i)th cell cannot be selected as a target cell, or that the (i)th cell does not support the GPRS or EDGE service, in other words, if it is determined that the (i)th cell does not satisfy at least one of the conditions of step 107, the mobile communication terminal proceeds to step 111 and increases the cell index (i) by one. The cell is given low priority if it does not support the GPRS or EDGE service.

After increasing the cell index (i) by one, the mobile communication terminal proceeds to step 113 and compares (i) with the number (Nc) of scanned cells to determine if the GPRS or EDGE service availability of all the scanned cells has been checked.

If (i) is less than or equal to Nc (i≦Nc), the mobile communication terminal returns to step 105, synchronizes to the (i)th cell, and receives and decodes BCCH information.

If (i) is greater than Nc (i>Nc), the mobile communication terminal ends the process.

As explained above in the exemplary embodiment, upon determination that none of the scanned cells supports the GPRS and the EDGE service, the mobile communication terminal conducts Camp-On in the order of cells which are sorted according to the reception power.

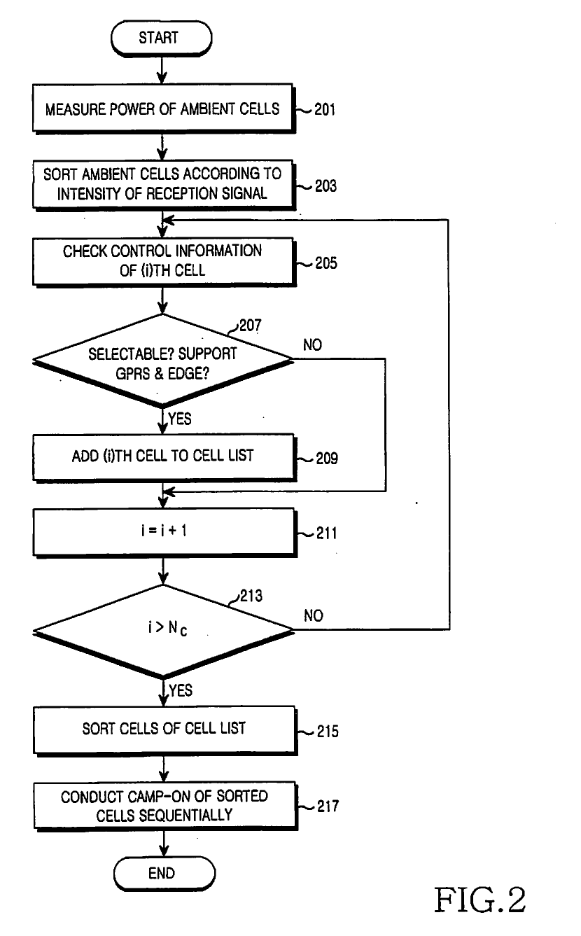

FIG. 2 is a flowchart illustrating the process of a PLMN selection of a mobile communication terminal according to the present invention.

In FIG. 2, the mobile communication terminal checks the signals of all the scanned cells and measures the reception power of the cells in step 201.

After measuring the reception power of the scanned cells at step 201, the mobile communication terminal proceeds to step 203 and sorts the ambient cells according to the measured reception power.

The mobile communication terminal proceeds to step 205, and synchronizes to the (i)th cell of the sorted cells, using the Synchronization Channel (SCH). Thereafter, the mobile communication terminal receives Broadcast Control Channel (BCH) of the (i)th cell and decodes the received signal. The cells, each having initial value 1, are indexed by (i) sequentially, in the order the cells are sorted.

After decoding the BCCH of the (i)th cell, the mobile communication terminal proceeds to step 207 and determines whether the (i)th cell can be selected as a target cell and whether the (i)th cell supports the GPRS and the EDGE service. Here, the mobile communication terminal checks the Location Area Identification (LAID) of System Information 3 (SI3) or System Information 4 (SI4) contained in the BCCH and determines whether the (i)th cell can be selected as a target cell. The LAID indicates service area of the cell.

The mobile communication terminal also checks GPRS indicator through the Rest Octet of SI3 or SI4 and determines whether the cell supports the GPRS service. The mobile communication terminal then checks the GPRS service parameters of SI13 contained in the BCCH and determines whether the cell supports the EDGE service according to the GPRS cell option of SI13.

If it is determined that the (i)th cell cannot be selected as a target cell, or that the (i)th cell does not support the GPRS or EDGE service, in other words, if it is determined that the (i)th cell does not satisfy at least one of the conditions of step 207, the mobile communication terminal proceeds to step 211 and increases the cell index (i) by one (i=i+1). The cell is given low priority if it does not support the GPRS or EDGE service.

If the (i)th cell can be selected as a target cell and supports the GPRS and the EDGE service, the mobile communication terminal proceeds to step 209 and gives the high priority to the (i)th cell and adds the (i)th cell to a cell list for the Camp-On.

The mobile communication terminal proceeds to S211 and increases the cell index (i) by one (i=i+1).

After increasing the cell index (i) by one, the mobile communication terminal proceeds to step 213 and compares (i) with the number (Nc) of scanned cells to determine if the all the scanned cells has been checked.

If (i) is less than or equal to Nc (i≦Nc), the mobile communication terminal returns to step 205, synchronizes to the (i)th cell, and decodes BCCH information.

However, if (i) is greater than Nc (i>Nc), the mobile communication terminal proceeds to step 215 and re-sorts the cells of the cell list in the order of: 1) cell priority; 2) the highest PLMN level; and 3) the intensity of reception signal power. The cell priority is determined according to the availability of GPRS or EDGE service, and the order of re-sorting the cells may be varied. For example, the cell, which supports the GPRS or EDGE service, has high priority, and the cell, which does not support the GPRS or EDGE service, has low priority. The order of re-sorting the cells of the cell list may be varied.

Next, the mobile communication terminal proceeds to step 217 and conducts Camp-On of the sorted cells in a sequence. The mobile communication terminal then ends the process.

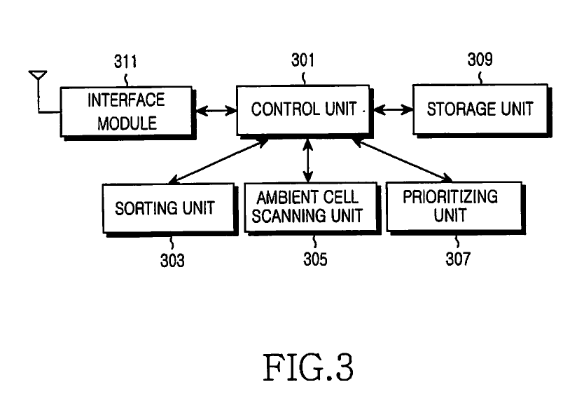

FIG. 3 is a schematic diagram of a mobile communication terminal according to the present invention. In an exemplary implementation explained below, the mobile communication terminal supports the packet data service.

In FIG. 3, the mobile communication terminal may include a control unit 301, a sorting unit 303, an ambient cell scanning unit 305, a prioritizing unit 307, a storage unit 309, and an interface module 311.

The control unit 301 controls the overall operations of the mobile communication terminal. For example, the control unit 301 may handle general processing and control for audio and data communication, and additionally, handle processing of the functions to select a target cell according to the GPRS and the EDGE service availability provided by the prioritizing unit 307, during the cell selection/reselection or PLMN selection.

The sorting unit 303 measures the intensity of the signals being received from the neighboring cells and sorts the cells according to the measured intensity of the received signals. The sorting unit 303 also sorts the cells of the cell list for Camp-On according to a predetermined order, during PLMN selection. For example, the sorting unit 303 may sort the cells in the order of the cell priority, the highest PLMN level and the intensity of received signals.

The ambient cell scanning unit 305 checks the LAC contained in the Broadcast Control Channel (BCCH) message being received from the neighboring cells and scans the cell which can conduct cell selection/reselection or PLMN selection.

The prioritizing unit 307 determines the GPRS and the EDGE service availability of the cells which are determined at the ambient cell scanning unit 305 to support the cell selection/reselection or PLMN selection, and prioritizes the cells. Specifically, the mobile communication terminal checks the SI13 parameters contained in the BCCH of the ambient cells and then determines whether the cells support the GPRS and the EDGE service. Next, the mobile communication terminal gives high priority to the cells having the GPRS and the EDGE service availability, while, conversely, the mobile communication terminal gives low priority to the cells without the GPRS and the EDGE service availability.

The storage unit 309 stores the program to control the overall operation of the terminal and the data which are temporarily generated during the execution of the program.

The interface module 311 communicates with the cell, and may include a Radio Frequency (RF) processing unit and a baseband processing unit.

In the aforementioned structure, the control unit 301 may control the sorting unit 303, the ambient cell scanning unit 305 and the prioritizing unit 307. Accordingly, the control unit 301 may operate as the sorting unit 303, the ambient cell scanning unit 305 and the prioritizing unit 307. Although these functions are described above as being performed in separate units, it is understood that this is only for convenience of explanation. For example, the control unit 301 may handle all or some of the functions of the above units.

As explained above, because GPRS and EDGE service availability of a target cell is determined during the cell selection/reselection or PLMN selection of a mobile communication terminal, a cell which can support the GPRS and the EDGE service can have high priority and the mobile communication terminal can use continuous packet data service.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of cell selection and reselection of a mobile communication terminal, comprising:
sorting observed cells according to the intensity of signals being received from the cells;
checking a control information of an (i)th cell of the sorted cells and determining whether the (i)th cell is selectable and reselected as a target cell and whether the (i)th cell supports General Packet Radio Service (GPRS) and Enhanced Data Rates for Global Evolution (EDGE) service; and
performing a Camp-On of the (i)th cell, upon determining that the (i)th cell is selectable and reselectable as the target cell and that the (i)th cell supports the GPRS and the EDGE service.

2. The method of claim 1, wherein the control information of the respective cells is checked through a Broadcast Control Channel (BCCH) being received from the respective cells.

3. The method of claim 1, wherein whether or not the (i)th cell is selectable as the target cell, is determined based on a System Information 3 (SI3) or a System Information 4 (SI4) contained in the Broadcast Control Channel (BCCH) of the (i)th cell.

4. The method of claim 1, wherein whether the (i)th cell supports the GPRS and the EDGE service, is determined according to the presence and absence of a System Information 13 (SI13) contained in the Broadcast Control Channel (BCCH) of the (i)th cell, and based on a GPRS parameter contained in the SI13.

5. The method of claim 1, further comprising:
setting low priority for the (i)th cell, if the (i)th cell does not support the GPRS or the EDGE service;
checking a cell control information of a (i+1)th cell and determining whether the (i+1)th cell is selectable and reselectable as a target cell and whether the (i+1)th cell supports the GPRS and the EDGE service;
performing a Camp-On of the (i+1)th cell, upon determining that the (i+1)th cell is selectable and reselectable as the target cell and that the (i+1)th cell supports the GPRS and the EDGE service.

6. The method of claim 1, further comprising performing Camp-On of the cells sequentially in the order the cells are sorted, if the ambient cells do not support the GPRS and the EDGE service.

7. A method of Public Land Mobile Network (PLMN) selection of a mobile communication terminal, comprising:
sorting observed cells according to the intensity of signals being received from the cells;
checking a control information of the sorted cells and determining whether the cells are selectable and reselected as a target cell and whether the cells support General Packet Radio Service (GPRS) and Enhanced Data Rates for Global Evolution (EDGE) service;
adding the cells into a Camp-On list, if the cells are determined to be selectable and reselectable as the target cell and support the GPRS and the EDGE service; and
re-sorting the cells of the Camp-On list and performing the Camp-On of the cells sequentially in the re-sorted order.

8. The method of claim 7, wherein the control information of the respective cells is checked through a Broadcast Control Channel (BCCH) being received from the respective cells.

9. The method of claim 7, wherein whether the cells are selectable as the target cell, is determined based on a System Information 3 (SI3) or a System Information 4 (SI4) contained in the Broadcast Control Channel (BCCH) of the cells.

10. The method of claim 7, wherein whether the cells support the GPRS and the EDGE service, is determined according to the presence and absence of a System Information 13 (SI13) contained in the Broadcast Control Channel (BCCH) of the cells, and based on a GPRS parameter contained in the SI13.

11. The method of claim 7, wherein the cells are re-sorted in the order of priority, PLMN level, and intensity of reception signal.

12. The method of claim 11, wherein the priority is given to the cells according to whether the cells support the GPRS and the EDGE service.

13. An apparatus for cell selection and reselection or Public Land Mobile Network (PLMN) selection of a mobile communication, the apparatus comprising:
a sorting unit which sorts observed cells according to the intensity of signals being received from the cells;
an ambient cell scanning unit which checks the cells sequentially in the sorted order, and determines whether the checked cell is selectable and reselectable as a target cell;
a prioritizing unit which gives priority to the cell determined by the ambient cell scanning unit to be selectable and reselectable as the target cell, according to whether the cell supports a General Packet Radio Service (GPRS) and an Enhanced Data Rates for Global Evolution (EDGE) service; and
a control unit which causes the cell selection and reselection or PLMN selection to be conducted according to the determined priority.

14. The apparatus of claim 13, wherein the sorting unit sorts the observed cells in the order of intensity of signals being received from the cells, and in the PLMN selection, re-sorts the cells which are selectable as the target cell and which support the GPRS and the EDGE service.

15. The apparatus of claim 14, wherein the sorting unit re-sorts the cells according to the priority, PLMN level, and intensity of reception signal.

16. The apparatus of claim 13, wherein the ambient cell scanning unit checks a System Information 3 (SI3) or a System Information 4 (SI4) contained in a Broadcast Control Channel (BCCH) of the cell and determines whether the cell is selectable and reselectable as a target cell.

17. The apparatus of claim 13, wherein the prioritizing unit determines whether the cell supports the GPRS and the EDGE service according to the presence and absence of a System Information 13 contained in the Broadcast Control Channel (BCCH) of the cell and based on a GPRS parameter contained in the SI13.

18. The apparatus of claim 13, wherein the prioritizing unit gives high priority if the cell supports the GPRS and the EDGE service, and gives low priority if the cell does not support the GPRS and the EDGE service.
